(19) United States
(12) Patent Application Publication
(10) Pub. No.: US 2009/0309527 A1
(43) Pub. Date: Dec. 17, 2009

(54) METHOD AND SYSTEM FOR DYNAMIC MOTOR BRAKING

(75) Inventors: B. Anuradha, Bangalore (IN); Monika Chawla, Haryana (IN); Arun Satapathy, Bangalore (IN)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/139,965

(22) Filed: Jun. 16, 2008

(51) Int. Cl. H02P 3/12

(52) U.S. Cl. 318/400.31; 318/379; 388/811

(57) ABSTRACT

A method of dynamic motor braking is disclosed herein. The method comprises: dissipating reverse energy in a motor within motor windings during a non-current supplying period of a commutation sequence by intermittently shorting the motor windings. The motor windings are shorted by simultaneously turning on all switches that are connected to a voltage source or to ground in a three-phase bridge motor control.

### FIELD OF THE INVENTION

The invention relates generally to electric motors, and more particularly to, a control strategy for dynamic braking of motors.

### BACKGROUND OF THE INVENTION

When a direct current motor rotates, each winding generates a voltage known as back electromotive force or back EMF, which opposes the main voltage supplied to the windings. The polarity of the back EMF is in opposite direction as that of the supply voltage to the motor, in normal operating conditions. A three-phase inverter bridge configuration is used to control the motor speed and torque.

Generally external hardware circuitry such as a braking resistor is used to dissipate the back EMF generated by the motor. However since this requires additional hardware it is beneficial to define a dynamic motor braking strategy to dissipate the back EMF.

In an example of a vascular tilt table used in medical imaging operations, the table uses a BLDC (Blade Less Direct Current) motor for positioning the table. A back EMF is generated while the motor rotates, which has a polarity in the direction opposite to that of the supply voltage. When the table moves towards gravity, the motor acts in generating mode and the polarity of the back EMF reverses. In generating mode, the back EMF aids the supply voltage. During this mode, the motor pumps energy back to the voltage supply, causing the supply voltage to increase beyond specific limits, which may cause damage to the table electronics. Hence the reverse energy needs to be dissipated, which is conventionally done through use of a braking resistor. These resistors are relatively bulky and generate heat. Further these braking resistors cannot be packed with normal switching circuitries associated with the motor, and have to be packed separately.

Thus there exists a need to maintain the supply voltage within the permissible limit by dissipating the reverse energy without any external hardware circuitry.

### SUMMARY OF THE INVENTION

The above-mentioned shortcomings, disadvantages and problems are addressed herein which will be understood by reading and understanding the following specification.

One embodiment of the present invention provides a method for dynamic motor braking. The method comprises: dissipating reverse energy in a motor within motor windings during a non-current supplying period of a commutation sequence by intermittently shorting the motor windings, wherein the motor windings are shorted by simultaneously turning on all switches that are connected to a voltage source or to ground in a three-phase bridge motor control.

In another embodiment, a motor braking method is disclosed. The method comprises: providing a pulse width modulated (PWM) signal for controlling a motor; triggering a three-phase bridge motor control using the PWM signal, wherein the three-phase bridge motor control is configured to have three legs connected in parallel, each leg having an upper switch and a lower switch connected in series, and wherein the upper switches and lower switches in all the legs together constitute a first row and a second row, respectively; and turning on all switches in a row simultaneously, the row being selected based on detecting at least two active switches in each row.

In yet another embodiment, a method of braking a brushless direct current motor is disclosed. The method comprises: providing a three-phase bridge motor control having three legs connected in parallel, each leg having an upper switch connected to a voltage source and a lower switch connected to ground, in series, wherein the upper and lower switches of the legs together are configured to be a first row and a second row; identifying reverse energy generated in the motor; selecting at least one row having at least two active switches in a row during a non-current conducting period; activating the inactive switch in the selected row; and dissipating the reverse energy through motor windings.

In yet another embodiment, a motor braking system is disclosed. The system comprises: a pulse width generator generating pulse width modulated (PWM) signals in a predefined commutation sequence; a plurality of switches connected as a three-phase bridge motor control; and a processor configured to generate a switch control signal with reference to reverse energy generated, the switch control signal being configured to trigger the switches such that motor windings are shorted intermittently.

In yet another embodiment, a patient table is disclosed. The table comprises: a patient carrying component movable in multiple directions; a brushless direct current (DC) motor for controlling movement of the patient carrying component; a three-phase bridge motor control having three legs connected in parallel, each leg having an upper switch connected to a voltage source and a lower switch connected to ground in series, the upper and lower switches of the legs configured to be a first row and a second row, respectively; and a controller configured to turn on all the switches in a row based on the reverse energy detected, the row being detected based on identifying at least two active switches in a row.

Various other features, objects, and advantages of the invention will be made apparent to those skilled in the art from the accompanying drawings and detailed description thereof.

### BRIEF DESCRIPTION OF THE DRAWINGS

FIG. 1 is a three-phase bride motor control configured to be used in a method of dissipating reverse energy as described in an embodiment of the invention;

FIG. 2 is a flowchart illustrating the braking method using the three-phase bridge motor control described in FIG. 1;

FIG. 3 is waveform chart showing the modified commutation sequence of a DC motor as described in an embodiment of the invention;

FIG. 4 is a flowchart illustrating a motor braking method as described in another exemplary embodiment of the invention;

FIG. 5 is a flowchart illustrating a method of braking a brushless DC motor as described in an embodiment of the invention;

FIG. 6 is a block diagram of a motor braking system as described in an embodiment of the invention;

FIG. 7 is a block diagram of a patient table as described in an embodiment of the invention; and

FIG. 8 is a block diagram of a vascular tilt patient table movement control having a braking system as described in an embodiment of the invention.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

Various embodiments of the present invention provide a control strategy for dissipating reverse energy in motor windings by circulating the current within the motor windings. The invention facilitates dissipating the reverse energy without using any external hardware circuitry. The reverse energy is dissipated within the motor windings itself. In an embodiment, the reverse energy is dissipated by shorting the motor windings intermittently such that the motor windings act as a resistor for dissipating the reverse energy.

In an embodiment, a patient table controlled by a DC motor is disclosed. The motor is controlled by a three-phase bridge motor control. A control strategy is defined for dissipating the reverse energy and regularizing the speed of the motor.

The term “reverse energy” referred to in the specification refers to back EMF generated.

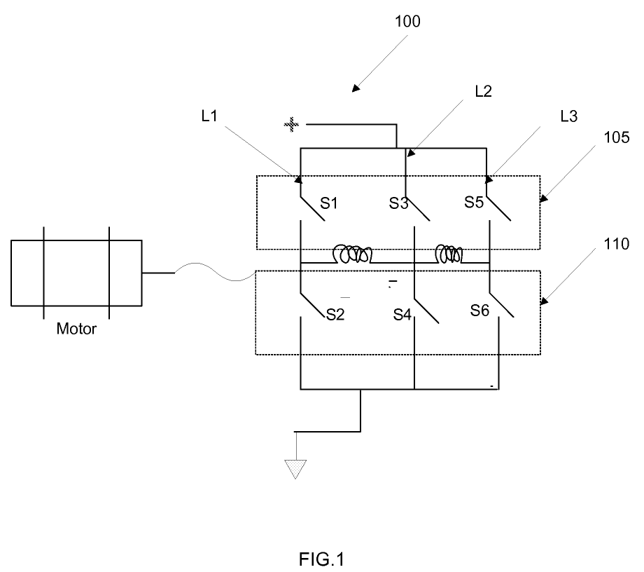

FIG. 1 is a three-phase bridge motor control configured to be used in a method of dissipating reverse energy as described in an embodiment of the invention. The three-phase bridge motor control 100 includes three legs of switches L1, L2, L3 connected in parallel. Each leg includes two switches connected in series. The first leg L1 includes two switches S1 and S2, the second leg L2 includes two switches S3 and S4 and the third leg L3 includes switches S5 and S6. The switches S1, S3, S5 (i.e., the upper switches in each leg) are connected to a supply voltage (“+”) and constitute a first row 105. The lower switches in the legs S2, S4 and S6 are connected to ground (“−”) and constitute a second row 110. The three-phase bridge motor control 100 is triggered by a Pulse Width Modulated (PWM) signal. At any point, two phases in the three-phase bridge motor control 100 are energized based on the motor's rotor position. The rotor position could be obtained from a Hall sensor (not shown), the rotor is assumed to be at one position until there is a change in the Hall sensor output. In a normal commutation sequence, S2 and S4 or S3 and S1 may be switched on, so that the motor is rotating. A back EMF is generated within the motor windings. This reverse energy is dissipated during a freewheeling period or non-current conducting period of the commutation sequence. During the freewheeling period, either S1 and S3 or S2 and S4 will be closed so that the reverse energy can be dissipated to an external circuitry.

In an embodiment, instead of dissipating the reverse energy to an external circuitry, the motor windings are shorted intermittently to dissipate the reverse energy within the motor windings. In an embodiment, the shorting of the motor is achieved by switching on S5 or S6 during the freewheeling period. If S1 and S3 are conducting, S5 is forced to be conducting or “ON” so that the motor is shorted and the motor resistance acts as a resistor to which the reverse energy can be dissipated. Similarly when S2 and S4 are conducting, the switch S6 is switched on to short the motor windings.

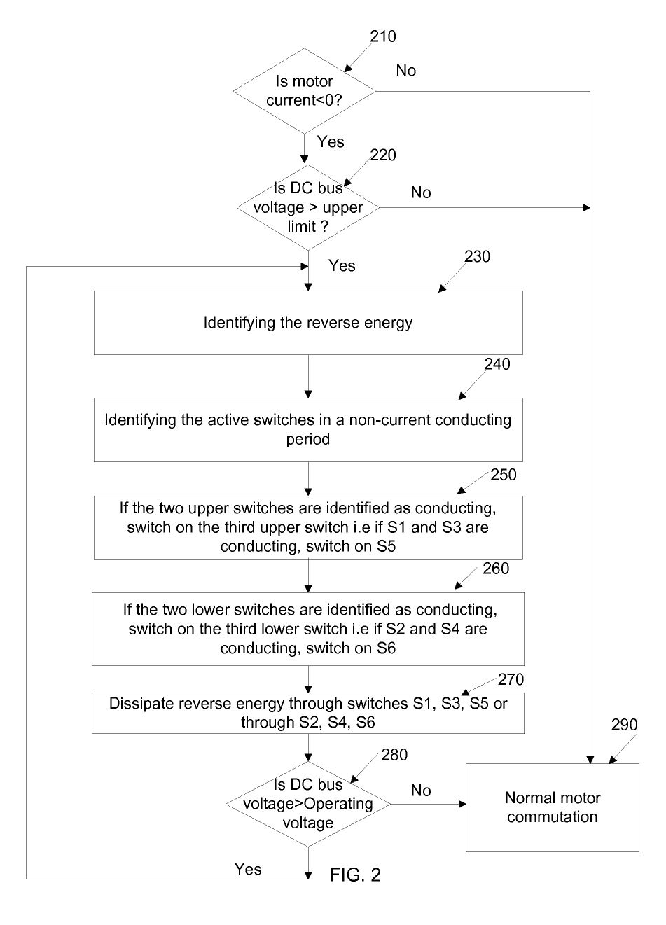

FIG. 2 is a flowchart illustrating a braking method using the three-phase bridge control described in FIG. 1. The reverse energy generated and the freewheeling period of the commutation sequence have to be identified to dissipate the reverse energy within the motor windings during the freewheeling period of the motor. At step 210, the direction of motor current is checked. During the generator mode of the motor, the reverse energy will be aiding the supply voltage. If the current is detected as less than zero, it is assumed that the current direction is in the reverse direction. If the current direction is normal, the motor is run using the normal commutation sequence as shown at step 280. If the current is detected as negative, at step 220, the supply voltage is checked. The supply voltage or the DC bus voltage is not allowed to be greater than a preset value. Since during the generator mode, the back EMF or the reverse energy aids the bus voltage, the operating bus voltage could be more than the DC bus voltage. A preset allowable limit is decided for the upper effective voltage. If the DC bus voltage is less than the allowable limit, the motor is configured to follow the normal commutation sequence as at step 280. However if the DC bus voltage is identified as more than the allowed preset allowable limit and if the motor current is less than zero, then the reverse energy is detected as at step 230. At step 240, the switches that are active in a non-current conducting period are identified. In a freewheeling period, at least two switches in a row will be active. The third switch in the selected row is switched on to short the motor windings. If the upper switches S1 and S3 are conducting, the switch S5 is also made conducting so that the motor windings are shorted as shown at step 250. Similarly, if the lower switches are conducting (i.e., if S2 and S4 are conducting), then S6 is also made conducting, as shown at step 260. Thus at step 270, the reverse energy is being dissipated either though the series of switches S1, S3, S5 or S2, S4, S6, by shorting the motor windings. A check is made at step 280, to determine whether the DC bus voltage is greater than the operating bus voltage. If the DC bus voltage is greater than the operating bus voltage, steps 230-270 are repeated to dissipate the reverse energy. Upon detecting the DC bus voltage as less than the operating bus voltage, the motor follows the normal commutation sequence as shown at step 290.

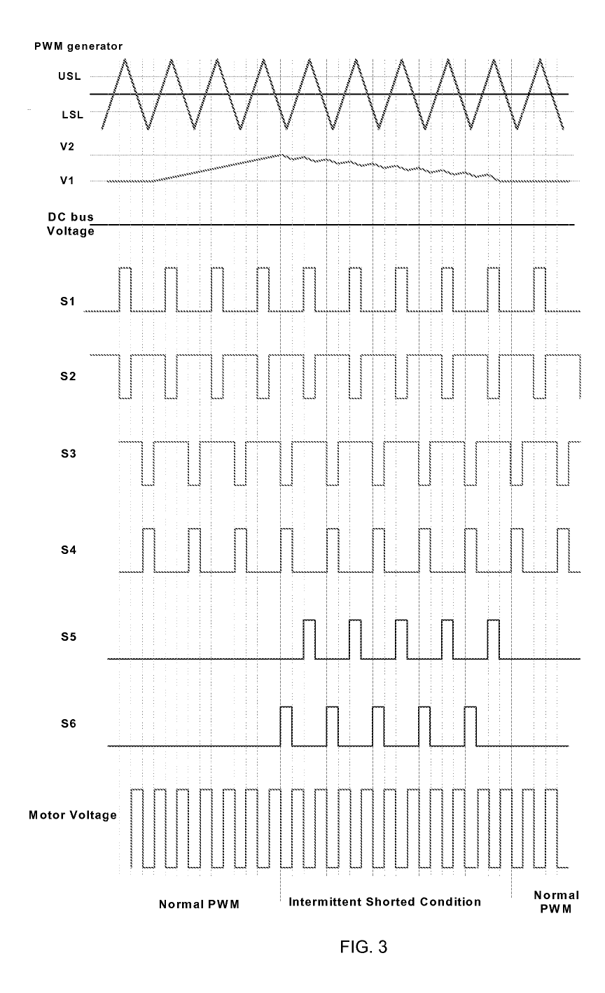

FIG. 3 is a waveform chart showing the commutation sequence of a DC motor as described in an embodiment of the invention. A pulse width modulated (PWM) signal is provided with an upper limit USL and lower set limit LSL, based on which the duty cycle of the pulse modulated signal is decided. The waveform is shown with 50% duty cycle. Operative voltage V1 is set at a particular level and allowable upper limit for bus voltage is kept as V2. V2 is greater than V1, and the difference is decided based on the application. The switching sequences of S1 to S4 are shown and the waveform for S5 and S6 indicates the points at which these switches are made conducting for shorting the motor windings. It is to be noted that when S1 and S3 are ON, S5 is switched ON, and similarly when S2 and S5 are ON, S6 is made ON for shorting the motor. Thus the PWM signal is modified based on the shorting requirement of the motor. The frequency and duration of shorting of the motor windings may depend on the motor speed, bus voltage, the back EMF generated, etc.

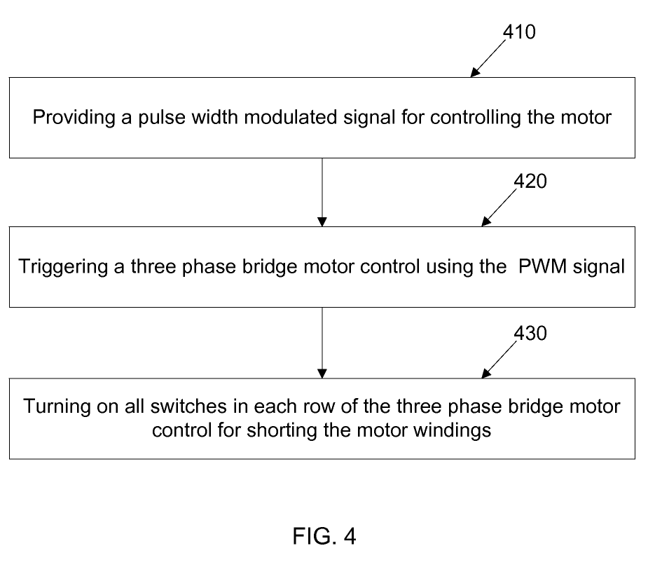

FIG. 4 is a flowchart illustrating a motor braking method as described in another exemplary embodiment of the invention. At step 410, a PWM signal is provided for controlling the motor. At step 420, a three-phase bridge motor control is triggered using the PWM signal. The three-phase bridge motor control is provided with three legs connected in parallel, each leg having two switches connected in series. The upper switches in each leg are connected to a voltage source and the lower switches of each leg are connected to ground. The upper and lower switches on each leg together constitute a first row and a second row, respectively. The reverse energy generated in the motor windings is identified and is identified by checking the direction of the current and effective supply voltage. At step 430, all the switches in a row are activated during a non-current conducting period. For this, a row having two active switches in a non-current conducting period is identified and the third switch in the row is made active so that the motor is shorted. Once the motor is shorted, the motor acts as a resistor and the reverse energy is dissipated in the motor windings. The frequency and duration of shorting of the motor is decided based on the motor speed, motor input voltage and the reverse energy generated within the motor. The reverse energy is dissipated during the non-current conducting or freewheeling period of the motor.

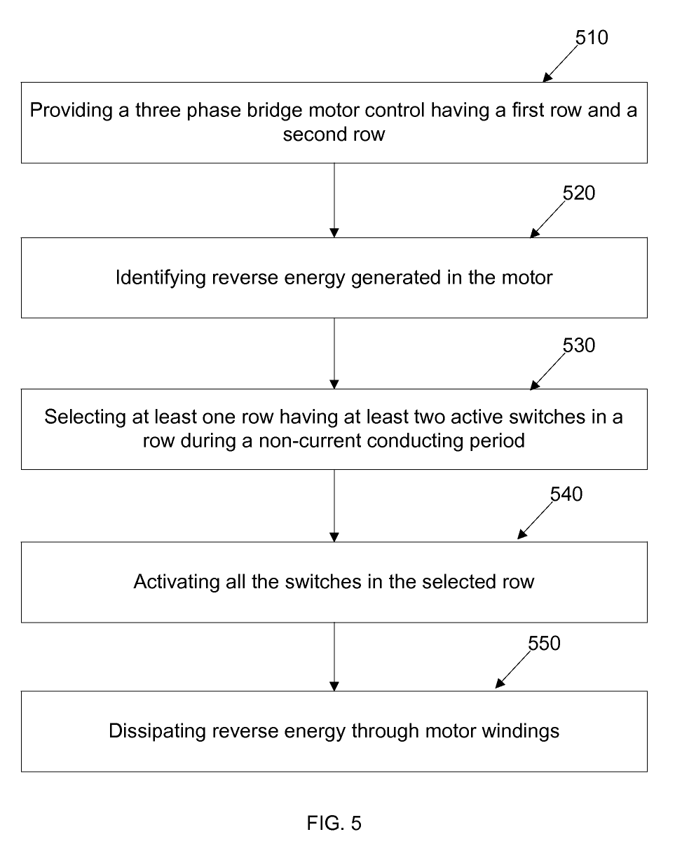

FIG. 5 is a flowchart illustrating a method of braking a brushless DC motor as described in an embodiment of the invention. At step 510, a three-phase bridge control is provided to control the rotation of the motor. The three-phase bridge motor control is provided with three legs connected in parallel, each leg having two switches connected in series. The upper switches in each leg are connected to a voltage source and the lower switches of each leg are connected to ground. The upper and lower switches constitute a first row and a second row, respectively. At step 520, the reverse energy generated in the motor is identified. In generator mode, the reverse energy aids the motor input voltage and the motor input voltage tends to be higher than the allowable motor input voltage. At this point the reverse energy generated needs to be dissipated. At step 530, during the non-current conducting period, a row of switches is identified with two active switches. During freewheeling period, at least two switches in a row will be active and that row is identified. At step 550, the inactive switch in the selected row is activated for shorting the motor windings. If the first row is selected, all the upper switches in all the legs will be activated and if the second row is selected, all the lower switches in all the legs will be activated. At step 560, the reverse energy is dissipated through the motor windings.

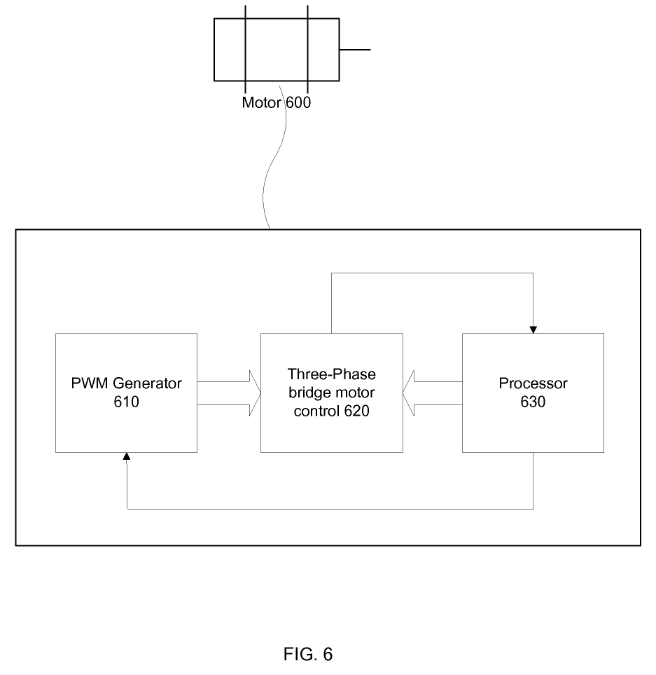

FIG. 6 is a block diagram of a motor braking system as described in an embodiment of the invention. The system is used to control a motor 600. The system includes a PWM generator 610 configured to generate a pulse width modulated signal. The duty cycle of the PWM signal may be varied based on the application. The PWM signal generated is provided with an upper limit and lower limit to define the duty cycle. A three-phase bridge motor control 620 is provided in association with the PWM generator 610. The three-phase bridge motor control 620 is explained in detail with reference to FIG. 1. The three-phase bridge motor control 620 is triggered using the PWM signal generated by the PWM generator 610. The three-phase bridge motor control 620 is configured to have a plurality of switches arranged to control the motor based on a predefined commutation sequence. A processor 630 is configured to alter the commutation sequence to dissipate the reverse energy within the motor windings. The processor 630 is configured to switch on all the switches in a row of three-phase bridge motor control 620 so that the motor windings are shorted and the reverse energy can be dissipated within the motor windings. The processor 630 is also configured to determine the duration and frequency of shorting of the motor based on motor speed, back EMF generated or the bus voltage or the effective programmable bus voltage. Further the processor 630 is configured to interact with the motor and identify the reverse energy generated within the motor windings. An interface may be provided to connect the PWM generator 610 with the three-phase bridge control 620. Also a driver unit may be provided to drive the three-phase bridge motor control 620.

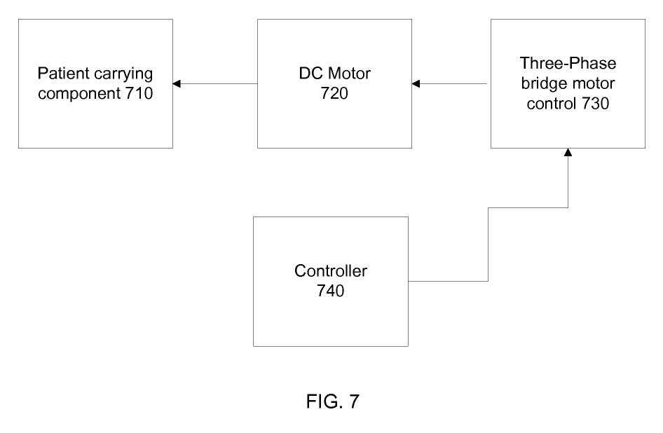

FIG. 7 is a block diagram of a patient table as described in an embodiment of the invention. The patient table is provided with a patient carrying component 710. The patient carrying component 710 is movable in vertical as well as horizontal directions. A brushless DC motor 720 is provided to control the movement of the patient table. A three-phase bridge motor control 730 is provided to control the motor. The three-phase bridge motor control is configured to receive a PWM signal based on which the commutation of the motor is determined. The three-phase bridge motor control is described in detail with reference to FIG. 1. A controller 740 is configured to alter the commutation sequence based on the application. The controller 740 is configured to identify reverse energy generated within the motor windings and based on the same commutation sequence is adjusted such that the motor is shorted intermittently to dissipate the reverse energy to the motor windings. In an embodiment, the controller 740 is configured to switch on all the switches in a row for shorting the motor windings.

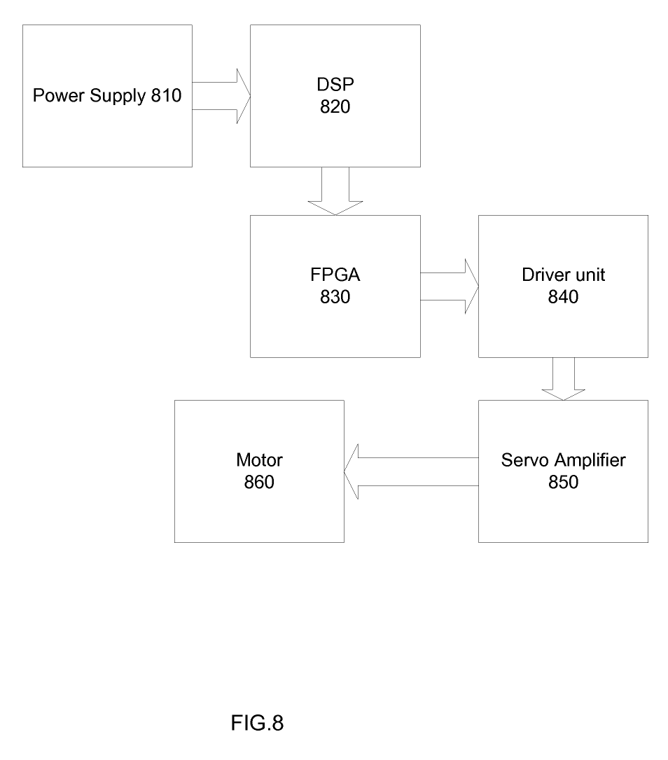

FIG. 8 is a block diagram of a vascular tilt patient table movement control having a braking system as described in an embodiment of the invention. A power supply 810 is provided to supply electrical power to various electrical components in the patient table and associated patient table moving system. A digital signal processor (DSP) 820 is configured to generate a pulse width modulated signal and process the signal to alter the commutation sequence. An interface, such as a Field-Programmable Gate Array (FPGA) 830, is configured to couple the DSP 820 to a servo amplifier 850. A driver unit 840 may be provided to drive the servo amplifier 850. A three-phase bridge motor control is part of the servo amplifier 850. The servo amplifier 850 is configured to control the motor 860. The DSP 820 identifies the reverse energy and, based on that, the commutation sequence is altered.

Thus the motor strategy proposed intermittently shorts the motor windings such that the motor rotation is unaffected. The advantages of various embodiments of the invention include eliminating the usage of an external hardware for dissipating the reverse energy. Further the method helps in improving the performance of the table or other object being moved by the motor by providing speed regulation and avoiding jerky movements of that object. Further the invention allows programmable voltage limits to detect the reverse energy and helps in improving the speed regulation. Further the electromagnetic interference is reduced due to continuous dissipation of the reverse energy. The technique allows each axis motor to dissipate reverse energy independently and thus there is no single point of failure and hence improves the patient safety if the motor is used to control a patient table.

Thus various embodiments of the invention describe a control strategy for braking of motors.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Exemplary embodiments are described above in detail. The assemblies and methods are not limited to the specific embodiments described herein, but rather, components of each assembly and/or method may be utilized independently and separately from other components described herein. Further the steps involved in the workflow need not follow the sequence in which there are illustrated in figures and all the steps in the work flow need not be performed necessarily to complete the method.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

I claim:

1. A method for dynamic motor braking comprising:
dissipating reverse energy in a motor within motor windings during a non-current supplying period of a commutation sequence by intermittently shorting the motor windings, wherein the motor windings are shorted by simultaneously turning on all switches that are connected to a voltage source or to ground in a three-phase bridge motor control.

2. A method as in claim 1, wherein the method further comprises: dissipating the reverse energy in the motor windings during an off period of a Pulse Width Modulated (PWM) control signal that controls the commutation sequence.

3. A method as in claim 1, wherein the switches in the three-phase bridge motor control circuitry are arranged as three legs connected in parallel, each leg having an upper switch and a lower switch connected in series, and wherein the upper switches on each leg connected to the voltage source constitute a first row and the lower switches on each leg connected to the ground constitute a second row.

4. A method as in claim 3, wherein the method further comprises: detecting at least two active switches in a row during the non-current supplying period of the commutation sequence and activating a third switch in the corresponding row.

5. A method as in claim 1, wherein the method further comprises: controlling shorting of the motor windings based at least on motor speed.

6. A motor braking method comprising:
providing a pulse width modulated (PWM) signal for controlling a motor;
triggering a three-phase bridge motor control using the PWM signal, wherein the three-phase bridge motor control is configured to have three legs connected in parallel, each leg having an upper switch and lower switch connected in series, and wherein the upper switches and lower switches in all the legs together constitute a first row and a second row, respectively; and
turning on all switches in a row simultaneously, the row being selected based on detecting at least two active switches in each row.

7. A method as in claim 6, wherein the method further comprises: identifying reverse energy generated in the motor.

8. A method as in claim 7, wherein the step of identifying the reverse energy comprises: checking direction of motor current.

9. A method as in claim 7, wherein the step of identifying the reverse energy comprises: checking effective supply voltage due to the reverse energy generated during a generator mode of the motor.

10. A method as in claim 6, wherein the step of turning on all the switches includes: shorting motor windings for dissipating the reverse energy.

11. A method as in claim 10, further comprising: controlling frequency and duration of shorting the motor windings based on the reverse energy generated.

12. A method as in claim 10, further comprising: controlling frequency and duration of shorting the motor windings based on motor input voltage.

13. A method as in claim 10, further comprising: controlling frequency and duration of shorting the motor windings based on motor speed.

14. A method of braking a brushless direct current motor comprising:
providing a three-phase bridge motor control having three legs connected in parallel, each leg having an upper switch connected to a voltage source and a lower switch connected to ground in series, wherein the upper and lower switches of the legs are configured to be a first row and a second row, respectively;
identifying reverse energy generated in the motor;
selecting at least one row having at least two active switches in a row during a non-current conducting period;
activating the inactive switch in the selected row; and
dissipating the reverse energy through motor windings.

15. A method as in claim 14, wherein the three-phase bridge motor control is configured to be controlled by a PWM signal.

16. A method as in claim 14, wherein the step of activating the inactive switch comprises: intermittently shorting the motor windings.

17. A method as in claim 16, wherein the step of activating the inactive switch further comprises: controlling frequency and duration of shorting the motor windings based on the speed of the motor.

18. A motor braking system comprising:
a pulse width generator generating PWM signals in a predefined commutation sequence;
a plurality of switches connected as a three-phase bridge motor control; and
a processor configured to generate a switch control signal with reference to reverse energy generated, the switch control signal being configured to trigger the switches such that motor windings are shorted intermittently.

19. A system as in claim 18, wherein the three-phase bridge motor control is configured to have three legs connected in parallel, each leg having an upper switch and lower switch connected in series, and wherein the upper switches constitute a first row and the lower switches constitute a second row, respectively.

20. A system as in claim 18, wherein the processor is configured to trigger all the switches in a row upon detecting reverse energy in motor, the switches being triggered during a free wheeling period of a commutation sequence.

21. A system as in claim 18, wherein the processor is further configured to identify at least two active switches in the freewheeling period in a row.

22. A system as in claim 18, wherein the system further comprises an interface configured to connect the PWM generator to the three-phase bridge motor control.

23. A system as in claim 18, wherein the system further comprises a driver unit for driving the three-phase bridge motor control.

24. A patient table comprising:
a patient carrying component movable in multiple directions;
a brushless DC motor for controlling movement of the patient carrying component;
a three-phase bridge motor control having three legs connected in parallel, each leg having an upper switch connected to a voltage source and a lower switch connected to ground in series, the upper and lower switches of the legs configured to be a first row and a second row, respectively; and
a controller configured to turn on all the switches in a row based on the reverse energy detected, the row being detected based on identifying at least two active switches a row.

25. A system as in claim 24, wherein the controller is configured to short a motor winding during a non-current supplying period with reference to the reverse energy generated.
